(19) United States
(12) Patent Application Publication
(10) Pub. No.: US 2015/0289021 A1
(43) Pub. Date: Oct. 8, 2015

(54) SYSTEM AND METHOD FOR COLLECTING VIEWER OPINION INFORMATION

(71) Applicant: Marlene MILES, Fredericksburg, VA (US)

(72) Inventor: Marlene MILES, Fredericksburg, VA (US)

(21) Appl. No.: 14/678,474

(22) Filed: Apr. 3, 2015

Related U.S. Application Data
(60) Provisional application No. 61/974,709, filed on Apr. 3, 2014.

(51) Int. Cl. H04N 21/466; G06Q 30/02

(52) U.S. Cl. CPC H04N 21/4667; G06Q 30/0201

(57) ABSTRACT

A system and method for collecting viewer opinion information may be provided. A trigger event relating to an event or program may be registered with a trigger event database, which in turn may initiate a query of the trigger event database and a user database to identify one or more target users that may be interested in the trigger event. The target users may receive a data request including a prompt. Responses to the data request may be received, processed, stored and statistically analyzed. Statistical data may be generated for consumption by one or more target users, general users of the system, the public, or broadcasters of an event or program.

### PRIORITY

This application claims priority to U.S. Provisional Patent Application Ser. No. 61/974,703 filed Apr. 3, 2014, the contents of which are hereby incorporated by reference in their entirety.

### BACKGROUND

Viewers of an event or program may wish to share their opinions about the event or program. For example, in the context of a sporting event, there are often official reviews of plays that occur during the course of a match or game. During an official review of a play, viewers may watch replays of the play in question and may form opinions as to whether the call was correct or incorrect. An individual viewer may wish to share his opinion with friends or with a general audience. Additionally, a viewer may wish to have access to information regarding the opinions of his or her friends, or the opinions of the general public as to accuracy of the call. Moreover, networks that broadcast events may be interested in the opinions of the general public or subgroups within the public to enhance the broadcast narrative surrounding the play. A viewer's desire to participate in an event or program by sharing their opinion or learning about the opinions of others may extend to events such as sporting events, performances, political events, speeches, news, television shows, movies or the like.

Accordingly, a system for efficiently collecting data describing viewers' opinions with respect to events or programs may be desired.

### SUMMARY

A system and method for collecting viewer opinion information may be provided. A trigger event relating to an event or program may be registered with a trigger event database, which in turn may initiate a query of the trigger event database and a user database to identify one or more target users that may be interested in the trigger event. The target users may receive a data request including a prompt. Responses to the data request may be received, processed, stored and statistically analyzed. Statistical data may be generated for consumption by one or more target users, general users of the system, the public, or broadcasters of an event or program.

In another exemplary embodiment, a non-transitory computer-readable readable medium storing instructions to be executed by a server device that controls queries amongst members of a group viewing an event, the instructions causing the server device to execute a series of steps may be described. The steps can include determining the occurrence of a trigger event; searching a user database; identifying target users; transmitting a data request to the target users; receiving responses from the target users; processing the responses from the target users; and performing an analysis of the responses from the target users.

A method of providing a statistical response, may further be shown and described in exemplary embodiments. The method can include housing user data in a database on a server; searching the user data after the occurrence of a trigger event with a processor; determining a plurality of users with traits associated with the trigger event based on data previously transmitted to the server; querying the plurality of users with traits associated with the trigger event with a processor that sends the query from the server to a plurality of communication devices associated with the plurality of users; receiving, with a transmitter, responses from the plurality of users; storing the responses from the plurality of users in a response database; sorting and processing the responses from the plurality of users with a processor; and generating a statistical response based on the sorted and processed responses.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

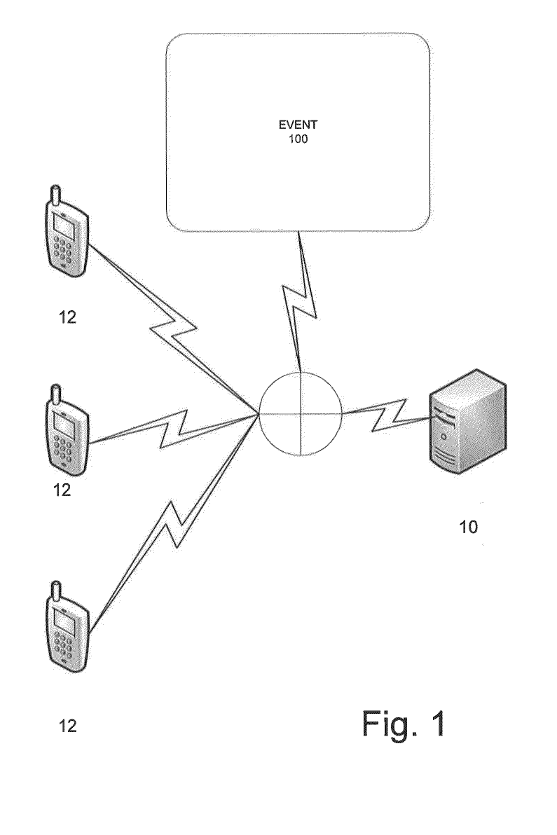

Exemplary FIG. 1 shows a system and method for collecting viewer opinion information.

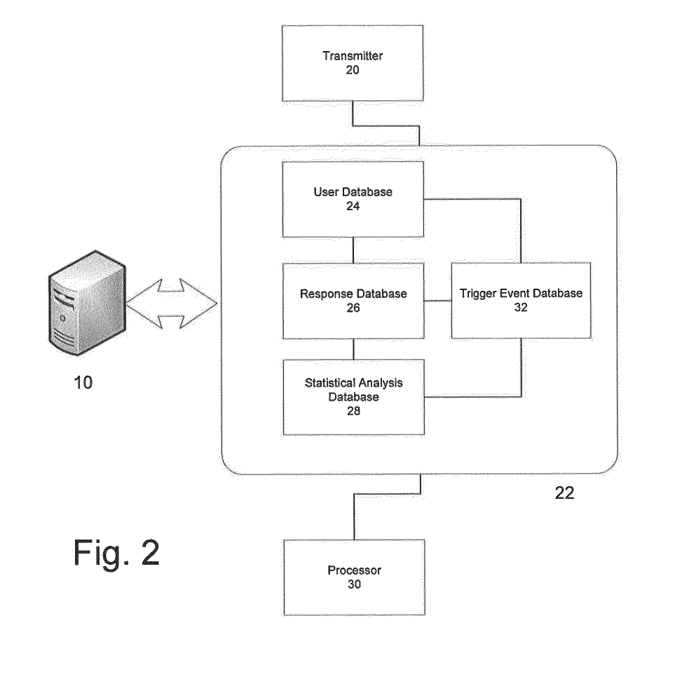

Exemplary FIG. 2 shows an exemplary event, server, and communication devices that may be used in a system and method for collecting viewing opinion information.

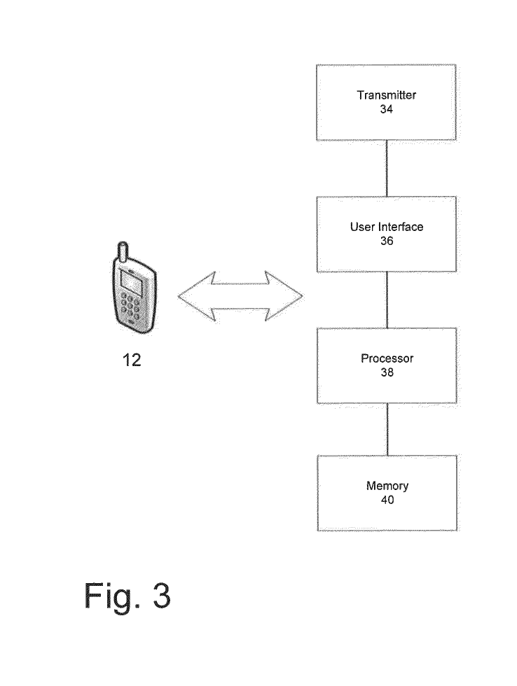

Exemplary FIG. 3 shows components of a server that may be used in a system and method for collecting viewing opinion information.

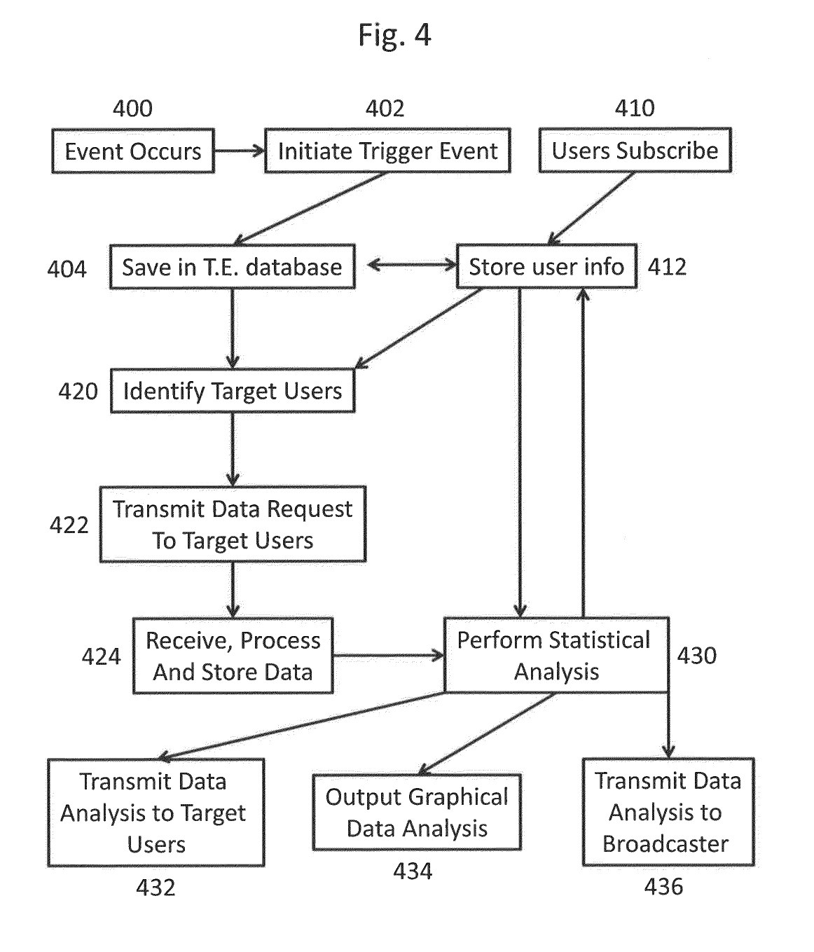

Exemplary FIG. 4 shows components of a communications device that may be used in a system and method for collecting viewing opinion information.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

According to at least one exemplary embodiment, and referring generally to FIGS. 1-5, a system and a method for collecting viewer opinion information may be disclosed. The figures may depict an exemplary embodiment of a system and method for collecting viewer opinion information. The system and method may be implemented in part or in full in an application that may be downloaded and installed, for example, on a user's mobile phone, personal computer, tablet or the like. Alternatively, users may communicate with the system through text message, message board, online survey, or other information transmission configurations. A user may incur a fee for downloading an application or subscribing to a website. Alternatively, the system and method may be provided to users for free.

Exemplary FIG. 1 indicates that an event 100 may occur. As described herein, event 100 may be any type of event that is viewable by any number of people. For example, event 100 could be a sporting match, a political debate, a news happening, a fund raiser, television show, or any other type of event. Further, event 100 may be an event that is viewable by a live audience, for example in a stadium or studio, may be viewable on television or online, or both, as desired. Further, in different exemplary embodiments, event 100 may be a live event or may be a taped broadcast.

Event 100 may be such that the time, location, involved parties, and other relevant information are known or communicated to the server 10. Server 10 may include any of a variety of components, described in more detail below, which allow for the storage, processing, and transmission of data. Server 10 can receive information about event 100 from a communication device or computer located at or proximate to event 100, a communication device having desired information about event 100, or may have information about event 100 entered directly. Server 10 can, in some exemplary embodiments, provide real time broadcasting or tracking of event 100 to a desired group of communication devices, for example communication devices 12.

Communication devices 12 may be any desired type of communication devices, for example smart phones, personal computers, laptop computers, tablets, smart televisions, or any other communication device or devices. Communication devices 12 may be such that they can store and execute a software application, such as, but not limited to, a mobile application.

It may further be appreciated that event 100 may be shown directly on communication devices 12, may be viewed in another environment, or may be viewed on another device. For example, methods and systems described herein could be utilized by an audience attending event 100 live, such as in a stadium, and may be realized through a communication link through server 10. Alternatively, a user of the exemplary method and system may view event 100 on television, on the Internet, or on any other viewing platform, as desired.

Exemplary FIG. 2 provides further details of elements that may be housed in server 10. For example, server 10 can have a transmitter 20, a memory resource 22, a user database 24, a response database 26, a statistical analysis database 28, a trigger event database 32, and a processor 30. It may further be appreciated that server 10 can have any other desired components or elements associated therewith, such as a display, input capabilities, additional memory, additional processors, and the like.

Still referring to exemplary FIG. 2, memory resource 22 may be a logical device that can provide a memory area of a physical device. Physical devices may be any known physical device including, but not limited to, computer readable storage media and non-transitory computer readable media. Memory resource 22 may be utilized to house any of a variety of information or conditions, including operating conditions of server 10 and any other desired data or information. Additionally, memory resource 22 may be segmented into a number of different memory blocks or other storage elements. For example, as above, memory 20 may include user database 24, response database 26, and statistical analysis database 28. Each database 24, 26, 28 may be formed as segmented memory modules or may be housed in separate memory components, as desired. Further, such databases may house specific data, for example, user database 22 may store information related to users of the system and method described herein, response database 24 may house information related to responses from queries generated by server 10, and statistical analysis database 28 may house information related to numerical comparisons, output graphs and graphics, or other demonstrative or conclusory data generated by processor 20 through comparisons and analysis. Trigger event database 32 may house information related to events that cause or enact, automatically or manually, server 10 to communicate with communication devices 12.

Referring now to exemplary FIG. 3, an exemplary communication device 12 may be shown. Communication device 12 may have any of a variety of components, for example a transmitter 34, a user interface 36, a processor 38, and a memory 40. It may be appreciated that communication device 12 may have any number of other components, as desired. For example, communication device 12 may be a smart phone, personal computer, laptop computer, tablet, smart television, or the like, and communication device 12 may have any features of such devices, include a display, input and output capabilities, and the like.

Communication device 12 may further act to communicate with other devices, such as server 10, and may receive data or information from any desired source. For example, communication device 12 may receive queries and transmit information to server 10. Additionally, communication device 12 may be capable of receiving any other desired data, for example video, picture, or text data related to event 100. User interface 36 may be such that a graphical user interface is displayed to a user in any of a variety of formats. User interface 36 can allow for users to view data, enter data, respond to queries, and the like.

An exemplary use of the system and method may be generally shown and described as follows with respect to the diagram shown in exemplary FIG. 4. A collection of users may subscribe to a service as described herein. These users may define a collection of users who subscribe 410 wherein the subscribed users may individually or collectively possess one or more traits that may describe the subscribed users. For example, subscribed users may use any of a variety of communication devices 12, such as those described above. Additional traits may include, but are not limited to, a user's name, age, geographic location, entertainment interests, sports interests, team interests, celebrity, athlete or politician interests, socioeconomic data, survey response history, or the like. The user trait information that is implemented in a particular embodiment may vary according to design parameters. User trait information and user indexes may be stored 412 in a user database 24 in memory 22, as shown previously.

An event or program may occur 400 in real-time, and some aspect of that event may be determined to be of potential interest to one or more subscribed users. A system controller may identify an aspect of interest and may initiate a trigger event 402. The system controller may be a human operator that views one or more events, identifies aspects of interests, and initiates trigger events 402. Alternatively, the system operator may be an automated processor that may initiate a trigger event in response to one or more predetermined cues. A trigger event may contain information describing the aspect of interest and the associated event or program 100 and one or more prompts to which interested users may respond by transmitting information to the system. The descriptive information associated with the trigger event may include, for example, the time that the associated event or program 100 began, the time that the aspect of interest occurred, text that describes the event, text that describes the aspect of interest, names of celebrities, athletes, politicians or other people involved, information regarding the number of people viewing the event, demographic information regarding the viewers of the event, or other information that may be relevant to the interests of subscribed users or to the business interests of the owners of the system embodiment. The trigger event 402 and the information associated with the trigger event 402 may be stored 404 in a trigger event database (e.g. trigger event database 32 of FIG. 2).

When a new trigger event 402 is registered 404 in the trigger event database, a processor may query the trigger event database and the user database to identify 420 one or more target users that may be particularly interested in the trigger event 402. Information associated with the trigger event 402 may be compared with trait information of one or more users as stored in the user database to determine whether a given user is likely to be interested in the event trigger 402. An algorithm may be implemented and run by a processor (such as processor 30 in exemplary FIG. 2) to generate a user interest estimation metric by quantifying the number of user interest traits of users in the user database a trigger event 402 may overlap with. Subscribed users may receive and view information on their communication device to inform the system that they are viewing or plan to view or attend a particular event or program 400 which may cause the user to be identified as interested in trigger events 402 that are associated with the particular event or program 400. Such information may be made at any time in advance of an event, at the start of an event, in real time during an event, or any other time, as desired. Alternatively, the start of event 400 may cause a system lock whereby no further users may be included as potential target users. Additionally, interest estimation metric for the user may be adjusted to reflect a user's elevated interest in events that the user has indicated that they are viewing or plan to view. A group of users that may be interested in the trigger event 402 may be identified 420 as target users.

Additionally, when a new user subscribes 110 and is registered in the user database 112, a processor in the server may query the trigger event database and the user database to identify trigger events 402 that the new user may be interested in. In this manner, registering new trigger events 402 may initiate queries of both the trigger event database 404 and the user database 412, and registering new users 110 may initiate queries of both the trigger event database 404 and the user database 412.

Following identification of one or more target users 420, the system may transmit a data request 422 to the target users. The data request 422 may include information associated with the trigger event 402. For example, the data request 422 may include a text description of the event or program 400 and/or a text description of the aspect of interest associated with the trigger event 402. The data request 422 may further include a prompt requesting the target users' opinions on the aspect of interest. The prompt may be a simple yes or no question, a multiple choice question, or a free-response question wherein a target user may respond with text data, voice data, image data or the like. The target user may submit a response to the data request by interacting with a visual display rendered by a system application, a webpage, or the like on their communication device and an interface associated with the communication device, as described above. Alternatively, the target user 420 may reply with a text message or a phone call via a mobile phone or the like, for example using the transmitter described with respect to exemplary FIG. 3. A target user 420 may incur a fee for responding to a data request 422. The fee may be a relatively small amount such as 25 cents, 50 cents, or the like. Alternatively, target users 420 may respond to a data request 422 for free.

Data from target user responses may be received, processed and stored 424 in a database, such as response database 26 of exemplary FIG. 2. The data may be received, for example, by a transmitter that is coupled to a network and later processed by a processor. User-submitted response data may be initially submitted 424 in varied, different, or inconsistent formats. For example, in a ‘yes or no’ question, a user might respond affirmatively by submitting 424 either ‘yes’ or simply ‘y.’ During processing 424, a wide variety of user response formats may be parsed into a standard data format. The processed response data may then be stored in a database, such as statistical analysis database 28.

Stored response data may be statistically analyzed 430 to generate statistics that may be of interest to target users 420, subscribed users 410, members of the public that may be viewing the event, or others. Polling statistics may be generated 430. For example, in a sporting event, response data may be analyzed 430 to determine what fraction of viewers agree or disagree with a particular call. Response data may be indexed, as part of the analysis 430, to the user that submitted the response such that information stored in the user database may be incorporated into the statistical analysis process 430. In this manner, user responses may be cross-referenced, amongst the databases described herein, against user information to identify patterns between user traits and response types. For example, the system and method might determine that during a sporting event, users that reside in a particular geographic region may tend to agree with a call that favors a local sports team.

Additionally, processed 424 and analyzed 430 data may be incorporated into the user database. A user's response to a particular trigger event 402 may be associated with that user's index in the user database 24. Statistically derived data may also be stored in the user database 24. For example, a user profile in the user database 24 may contain a history of trigger event responses, how often the user tends to respond affirmatively or negatively, and how often that user agrees with some set of other users that have one or more traits in common or in contrast with the user. This data may then be used to determine other related or possible trigger events 402 for a user or group of users, for example, a group of users in a defined geographic area.

Results from the statistical analysis 430 may be transmitted to target users 420 that responded to data requests 422. For example, a target user 420 may submit their opinion with regard to a trigger event 402, and after doing so, they may receive information regarding opinion trends among other viewers of the event or program 400. Target users 420 may be able to request more detailed information such as cross-tabulations to identify how user opinions vary or correlate with selected user traits. Users may incur a fee for requesting more detailed information. This fee may be a small fee such as 25 cents, 50 cents, or the like, in some exemplary embodiments. Alternatively, users may receive this information for free.

The analyzed data 430 may be graphically outputted 434 on a display such as a computer display, a mobile phone display, a television or the like on the communication device 12. The graphical outputs 434 may include, for example, graphs, charts, cartoons or other images that may convey computed statistics relevant to an event or program 400 or trigger event 402. The system may be programmed to automatically render graphical outputs 434.

The analyzed data 430 may also be provided to one or more broadcasters 136 that may be broadcasting the event or program 400 to members of the public. One or more graphical outputs 434 may be provided to a broadcaster 436 so that the broadcaster 436 may use the graphical output 434 to inform and entertain viewers. Broadcasters 436 may incur a fee for accessing analyzed data 430 or for displaying graphical outputs 434. Alternatively, broadcasters 436 may access data 430 or display graphical outputs 434 for free.

In another exemplary embodiment, the system for collecting user opinion data may also collect opinion data that is not directly connected to a particular event or program. Trigger events 402 may be initiated by an operator or may be automatically generated at predetermined times or intervals to query subscribed users 400 or a subgroup thereof about a particular topic. Trigger events 402 that are not associated with a particular event may be generated during times when a topic is of general interest to the public. For example, trigger events 402 relating to politics could be generated during the months preceding an election to capitalize on heightened interest. Alternatively, trigger events 402 could be initiated to maintain a connection with a user during a period of relatively low interest. For example, trigger events 402 relating to a sports team might be generated during that team's off-season. Providing prompts and data requests 422 to users 400 during relatively low-interest periods may encourage user familiarity with the system and may increase user activity during live events.

In one exemplary embodiment, a system and method may collect information relating to viewers opinions of an official call during a sporting event. Following a controversial or unclear call in a sporting event, officials may spend a period of time reviewing an on-field call. During this time, viewers may watch replays of the play in question. An operator of the system may initiate a trigger event relating to the call and the play in question. Target users 420 may be identified from a user database 412 wherein the target users 420 may have a particular interest in the sporting event or may be watching the sporting event. A data request 422 including a prompt such as, for example, “Do you agree with the call?” may be transmitted to the target users via, for example, text message, mobile application, internet website or the like. Target users 420 may transmit their responses, and the response data may be logged and statistically analyzed. Target users 420 may subsequently receive information that may include, for example, how many users responded to the data request, how many voted ‘yes’ or ‘no’, and how the response data may have correlated with user demographics such as age or geographic location. At the end of a game or at some later time, target users 420 may receive information indicating how many times or how often they arrived at the ‘correct choice’ as determined by the outcome of the official review.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A non-transitory computer-readable readable medium storing instructions to be executed by a server device that controls queries amongst members of a group viewing an event, the instructions causing the server device to execute the steps of:
determining the occurrence of a trigger event;
searching a user database;
identifying target users;
transmitting a data request to the target users;
receiving responses from the target users;
processing the responses from the target users; and
performing an analysis of the responses from the target users.

2. The non-transitory computer-readable medium of claim 1, wherein the user database houses data associated with traits of subscribed users.

3. The non-transitory computer-readable medium of claim 1, wherein the identifying of the target users is performed by a processor comparing user data to data associated with the trigger event.

4. The non-transitory computer-readable medium of claim 1, wherein the data request transmitted to the target users relates to the trigger event.

5. The non-transitory computer-readable medium of claim 1, wherein the processing of the responses is performed by a processor.

6. The non-transitory computer-readable medium of claim 1, wherein the processing of the responses determines common factors amongst the responses to sort the response.

7. The non-transitory computer-readable medium of claim 1, wherein the processing of the responses associates responses with the target users.

8. The non-transitory computer-readable medium of claim 1, wherein the performing of a statistical analysis comprises generating a statistical graph of like responses.

9. The non-transitory computer-readable medium of claim 1, further comprising transmitting the statistical analysis to the target users.

10. The non-transitory computer-readable medium of claim 1, further comprising transmitting the statistical analysis to a third party outside of the user database.

11. A method of providing a statistical response, comprising:
housing user data in a database on a server;
searching the user data after the occurrence of a trigger event with a processor;
determining a plurality of users with traits associated with the trigger event based on data previously transmitted to the server;
querying the plurality of users with traits associated with the trigger event with a processor that sends the query from the server to a plurality of communication devices associated with the plurality of users;
receiving, with a transmitter, responses from the plurality of users;
storing the responses from the plurality of users in a response database;
sorting and processing the responses from the plurality of users with a processor; and
generating a statistical response based on the sorted and processed responses.

12. A method of providing a statistical response, further comprising transmitting the generated statistical response to at least one of the users and a third party.
